(19) United States
(12) Patent Application Publication
(10) Pub. No.: US 2017/0359632 A1
(43) Pub. Date: Dec. 14, 2017

(54) Method of Inter-Frequency or Inter-Radio Access Technology Measurement

(71) Applicant: MediaTek Singapore Pte. Ltd., Singapore (SG)

(72) Inventors: Wenze Qu, Beijing (CN); Jianwei Zhang, Beijing (CN)

(21) Appl. No.: 15/614,590

(22) Filed: Jun. 5, 2017

(30) Foreign Application Priority Data
Jun. 14, 2016 (CN) 201610423954.2

(51) Int. Cl. H04Q 1/45; H04B 17/373; H04B 17/26; H04W 36/30; H04W 16/14; H04W 36/18; H04W 24/10; H04B 17/24

(52) U.S. Cl. CPC H04Q 1/45; H04W 24/10; H04B 17/373; H04B 17/24; H04W 36/30; H04W 16/14; H04W 36/18; H04B 17/26

(57) ABSTRACT

A method of inter-frequency or inter-RAT (Radio Access Technology) measurement for a user equipment in a wireless communication system is provided. The method comprises receiving configuration information of measurement gap from a network of the wireless communication system, obtaining a list of frequencies or RATs to be measured, and allocating at least two of the frequencies or RATs in the measurement gap, to perform cell search or measurement on the at least two frequencies or RATs within the measurement gap.

### BACKGROUND

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

In LTE system, which is commercially called 4G LTE, a UE needs to monitor or measure a signal quality of a neighbor cell (i.e. frequency channel quality or wireless signal strength) for a cell selection/reselection or handover. The neighbor cell may include an intra-frequency cell, inter-frequency cell or inter radio access technology (inter-RAT) cell. According to the current operating frequency band of the UE, the measurement operation may be divided into two measurement types, which are intra-frequency measurement and inter-frequency/inter-RAT measurement. Also, the measurement operation may be divided into intra-RAT measurement and inter-RAT measurement, depending on the radio access technology (RAT) to be measured. The intra-frequency/intra-RAT measurement is predominantly performed for the mobility within the same frequency/RAT (i.e., between cells with the same frequency/RAT), whereas the inter-frequency/inter-RAT measurement is predominantly performed for the mobility between different frequencies/RATs (i.e., between cells with different frequencies/RATs). Currently, the inter-frequency/inter-RAT measurement is performed during the uplink/downlink measurement gap which is configured by the network. Specifically, during the measurement gap, the uplink and downlink data transmissions are prohibited, but the inter-frequency/inter-RAT measurement can be performed. In addition, inter-RAT may include 3G mobile communication system supporting frequency-division duplex (FDD) and/or time-division duplex (TDD) transmission, Global System for Mobile communications (GSM), Code Division Multiple Access 2000 (CDMA 2000) system, Wireless Fidelity (WiFi) based on IEEE 802.11, etc.

The cell search and measurement is aims at measuring a paging channel (i.e. certain time and frequency), so as to monitor cell quality or search for a possible candidate cell. For example, 4G LTE measurement is performed on Cell Reference Signals (CRS), to obtain Reference Signal Receive Power (RSRP) and Reference Signal Receiving Quality (RSRQ). In addition, 3G TDD measurement is performed on Received Signal Code Power (RSCP) of Primary Common Control Physical Channel (P-CCPCH) in a first time slot TSO of a subframe, and GSM measurement is performed on Received Signal Strength Indicator (RSSI) and Base Station Identity Code (BSIC). The amounts of time required for measurement performed on these signals are different due to different signal types. For example, 3G TDD measurement performed on P-CCPCH RSCP takes about 1 ms, whereas GSM measurement performed on RSSI takes less than 1 ms. Besides, GSM measurement on BSIC requires more time and has to be performed periodically.

Take 4G network for example, there are two patterns for measurement gap configuration, namely Gap Pattern 0 (GP0) and Gap Pattern 1 (GP1), wherein the cycles of the GP0 and GP1 are 40 ms and 80 ms respectively, and each measurement gap has a length of 6 ms. In the conventional inter-frequency or inter-RAT measurement, each 6 ms measurement gap is configured for a single frequency. In such a manner, if there are four frequencies or RATs required for measurement, only one frequency or RAT can be measured or searched in every 6 ms measurement gap. Thus, it requires 160 ms or 320 ms to complete the measurement on all of the four frequencies or RATs with GP0 and GP1 configuration.

With 4G network developments, there are more and more 4G, 3G and GSM frequencies or RATs in the network. However, only one frequency or RAT can be measured within the 6 ms measurement gap, which results long time to complete measurement on all frequencies or RATs. For example, suppose a UE supports ten frequencies, and the cycle of the measurement gap is 80 ms. Then, it requires 800 ms to complete the measurement on all of the ten frequencies. If the times of the measurement or the number of cells to be measured in each frequency is increased, it would require more time to perform the measurement, which causes long time period of data transmission interruption on the UE. As a result, how to improve the measurement gap utilization for inter-frequency or inter-RAT measurement becomes a significant subject.

In addition, the 4G network supports carrier aggregation function, which enables the UE use multiple component carriers for transmission or reception. In a word, a UE supporting two component carriers can receive two 4G signals in different frequencies simultaneously. In the current 3GPP communication standard, at most five component carriers are defined in carrier aggregated. However, the current inter-frequency or inter-RAT measurement operation of UE does not take into a consideration the capacity that the UE may use multiple component carriers.

### SUMMARY

It is therefore an objective to provide a method of inter-frequency or inter-RAT measurement to solve the above problem.

The present disclosure provides a method of inter-frequency or inter-RAT measurement for a user equipment in a wireless communication system. The method comprises receiving configuration information of measurement gap from a network of the wireless communication system, obtaining a list of frequencies or RATs to be measured, and allocating at least two of the frequencies or RATs in the measurement gap, to perform cell search or measurement on the at least two frequencies or RATs within the measurement gap.

The present disclosure provides a user equipment for inter-frequency or inter-RAT measurement in a wireless communication system. The user equipment comprises at least one radio frequency module, and a processor, coupled to the at least one radio frequency module, for receiving configuration information of measurement gap from a network of the wireless communication system via the at least one radio frequency module, obtaining a list of frequencies or RATs to be measured, and allocating at least two of the frequencies or RATs in the measurement gap, to perform cell search or measurement on the at least two frequencies or RATs within the measurement gap.

The present disclosure provides a method for the inter-frequency or inter-RAT measurement, to increase efficiency of the measurement gap, and therefore reducing the time to complete the measurement on all of the frequencies or RATs and effect of transmission interruption, as to increase the transmission efficiency of the UE.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an embodiment of the invention.

FIG. 2 is a schematic diagram of an exemplary user equipment according to an embodiment of the invention.

FIG. 2A is a schematic diagram of a user equipment according to an embodiment according to another embodiment of the invention.

FIG. 3 is a flowchart of an exemplary process according to the present disclosure according to an embodiment of the invention.

FIG. 4 is a schematic diagram of a measurement gap configuration according to an embodiment of the invention.

FIG. 5 is a flowchart of a measurement operation according to an embodiment of the invention.

FIG. 6 is a schematic diagram of a measurement gap configuration according to an embodiment of the invention.

FIG. 7 is a flowchart of a measurement operation according to the present disclosure according to an embodiment of the invention.

FIG. 8 is a schematic diagram of a measurement gap configuration according to an embodiment of the invention.

FIG. 9 is a flowchart of a measurement operation according to the present disclosure according to an embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

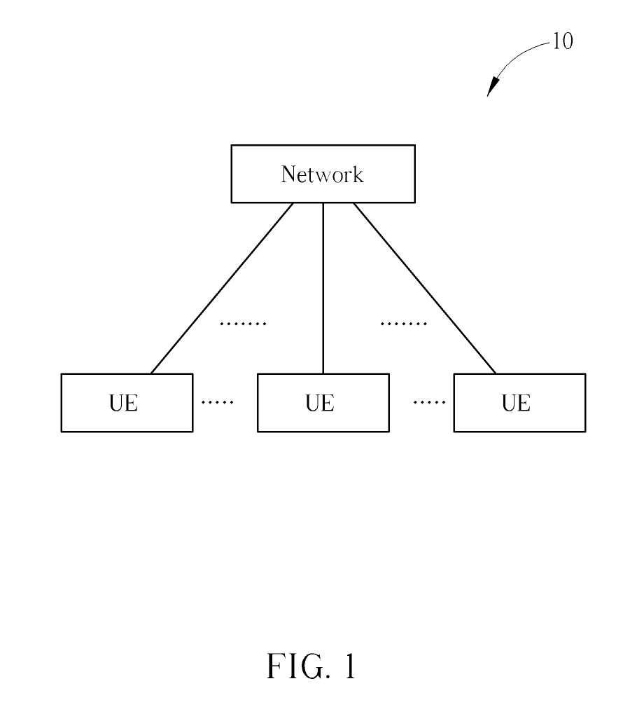

Please refer to FIG. 1, which illustrates a schematic diagram of a wireless communication system 10 according to an embodiment of the invention. Briefly, the wireless communication system 10 comprises a network and a plurality of user equipments (UEs). The wireless communication system 10 can be a Long Term Evolution (LTE) system or a LTE-Advanced system. In the LTE system, the network can be referred to as an evolved Universal Terrestrial Radio Access Network UTRAN (E-UTRAN) comprising a plurality of base stations (i.e., evolved Node Bs, eNBs). The UEs can be devices such as mobile phones, computer systems, etc. This terminology will be used throughout the application for ease of reference. However, this should not be construed as limiting the disclosure to any one particular type of network. In some examples, the network and the UE may be seen as a transmitter or receiver according to transmission direction, e.g., for uplink (UL), the UE is the transmitter and the network is the receiver, while for downlink (DL), the network is the transmitter and the UE is the receiver.

In addition, the UE includes at least a radio frequency (RF) module, each RF module includes at least a RF chain, wherein each RF chain is corresponding to a frequency band. When the network requests the UE to perform inter-frequency or inter-RAT measurement, whereby the UE is required of a measurement gap, the network (e.g. eNB) allocates the measurement gap to the UE. Note that, within the measurement gap, the UE transfers the RF chain to another frequency band which is to be measured, to perform inter-frequency or inter-RAT measurement, and therefore collects quality parameters, such as RSRP, RSRQ or RSSI of neighbor cell(s). After that, the UE transfers the RF chain to the original frequency band.

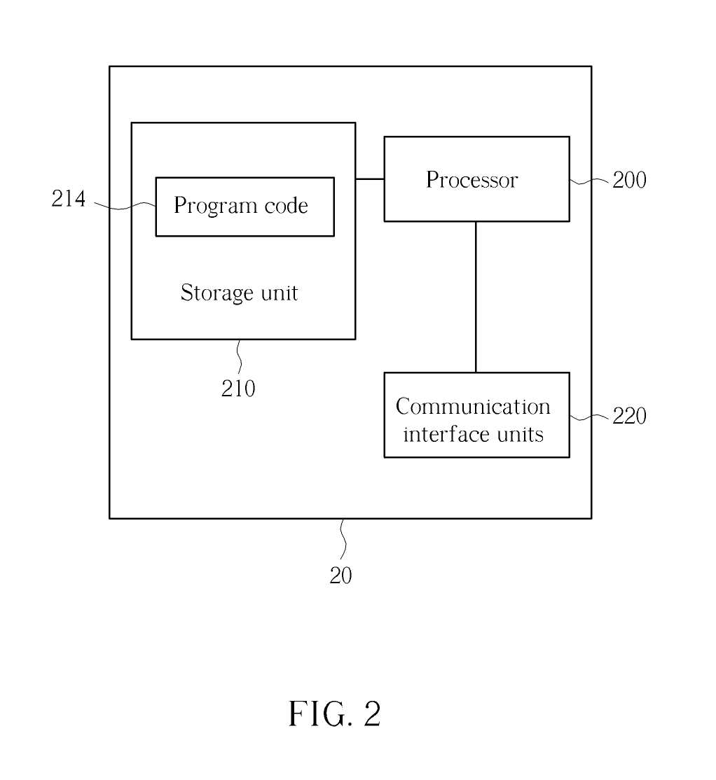

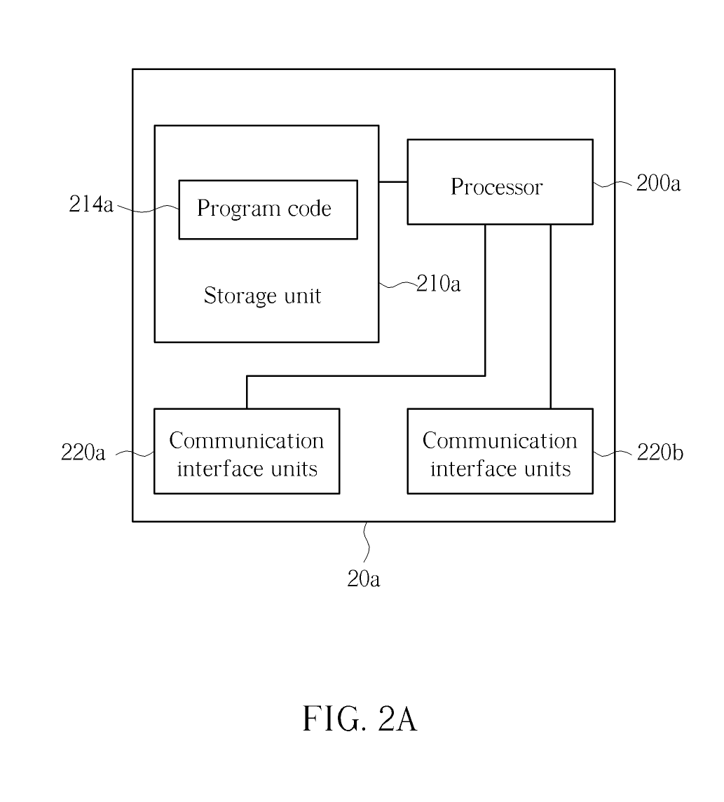

FIG. 2 is a schematic diagram of an exemplary UE 20 according to an embodiment of the invention. The UE 20 can be the UE of FIG. 1 and comprises a processor 200 such as a microprocessor or Application Specific Integrated Circuit (ASIC), a storage unit 210 and a communication interface unit 220. The storage unit 210 may be any data storage device that can store program code 214, which can be fetched and executed by the processor 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interface unit 220 is preferably a radio transceiver or a RF module, and can exchange wireless signals with the network according to processing results of the processor 200.

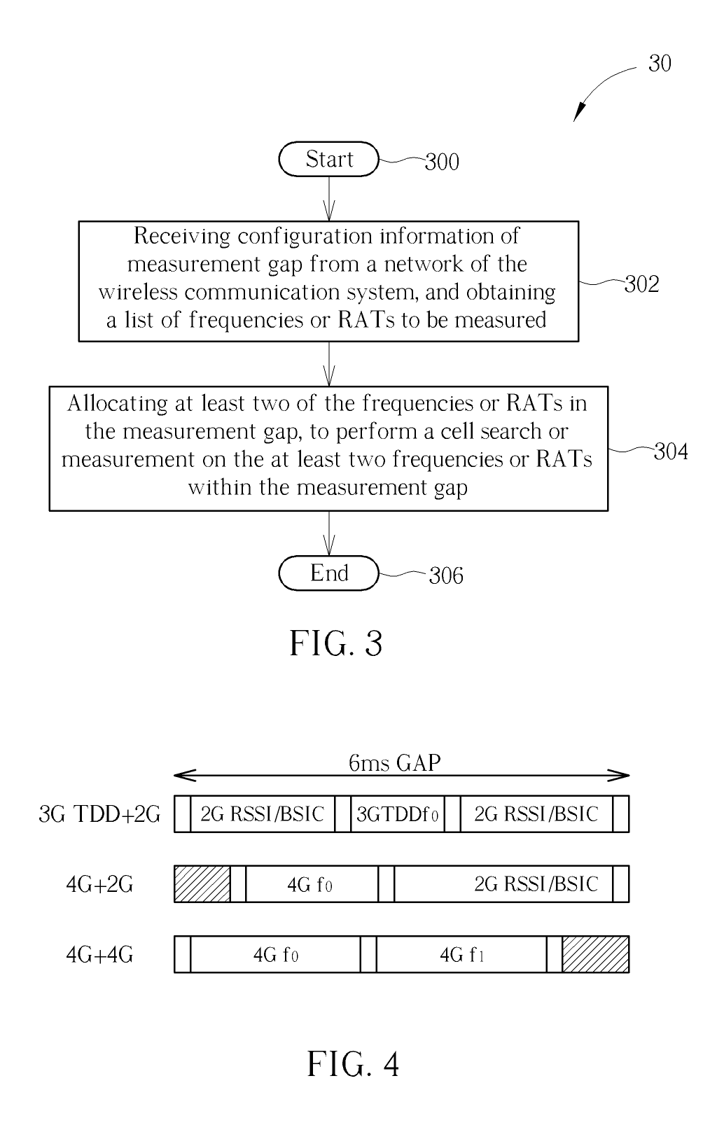

In practical, a cell search and measurement in a frequency or a RAT may be less than 6 ms within the 6 ms measurement gap configured by the network. For example, 3G TDD measurement requires at most 1.5 ms, and thus there is 4.5 ms left within the 6 ms measurement gap. As to the 4G LTE measurement, for a certain frequency or RAT, there may be 4 ms left within the measurement gap. By increasing the utilization efficiency of the measurement gap, the present disclosure can improve the conventional inter-frequency or inter-RAT measurement operation. Reference is made to FIG. 3, which is a flowchart of a process 30 according to an embodiment of the present disclosure. The process 30 is adopted by a UE (e.g., the UE 20 in FIG. 2) for handling the measurement gap allocated to the UE. The process 30 may be compiled into a program code 214 to be stored in the storage unit 210, and may include the following steps:

Step 300: Start.

Step 302: Receiving configuration information of measurement gap from a network of the wireless communication system, and obtaining a list of frequencies or RATs to be measured. The list may be configured by the network, stored in the UE or predefined for the UE.

Step 304: Allocating at least two of the frequencies or RATs in the measurement gap, to perform a cell search or measurement on the at least two frequencies or RATs within the measurement gap. For example, the processor of the UE allocates the 6 ms measurement gap for the measurements of two frequencies or RATs (e.g., 4G and 3G TDD measurements, 3G TDD and 2G measurements, and measurements on different frequencies in 4G)

Step 306: End.

According to the process 30, after the UE receives the measurement gap configuration from the network, the UE allocates at least two frequencies or RATs of the plurality of measuring frequencies or RATs in at least one measurement gap. In other words, within one measurement gap, the UE can perform measurement for multiple frequencies or RATs, so that the time for performing measurement on all of frequencies or RATs in the measuring list is reduced and the time of transmission interruption resulted from the measurement gap is reduced, which improves the service quality.

In order to realize measurement on at least two frequencies or RATs in one measurement gap, the detailed operation is described as follows. Please refer to FIG. 4, which is a schematic diagram of a measurement gap configuration according to an embodiment of the invention. In this embodiment, suppose there is one available RF module for measurement. As shown in FIG. 4, the UE divides the measurement gap into multiple time periods within the 6 ms measurement gap GAP (i.e. based on timing information associated with the frequency or RAT measurement operation, wherein the timing information includes at least two of a start time, duration time, and end time of the measurement operation), and allocates the periods of the measurement gap GAP to different frequencies or RATs. Thus, the UE can perform measurement on different frequencies or RATs within one measurement gap. For example, the UE can perform measurement for 3G and 2G networks (e.g., measuring RSSI or BSIC of 2G network and 3G frequency 3G TDD f₀), for 4G and 2G networks (e.g., measuring RSSI, BSIC of 2G network and 4G frequency 4G f₀) or for different frequencies in 4G network (e.g., two 4G frequencies 4G f₀ and 4G f₁) within one measurement gap GAP. Note that, the number or the combinations of frequencies or RATs measured within a single measurement gap GAP is not limited herein. Measurement on two or at least two frequencies or RATs within one measurement gap GAP belongs to the scope of the present disclosure.

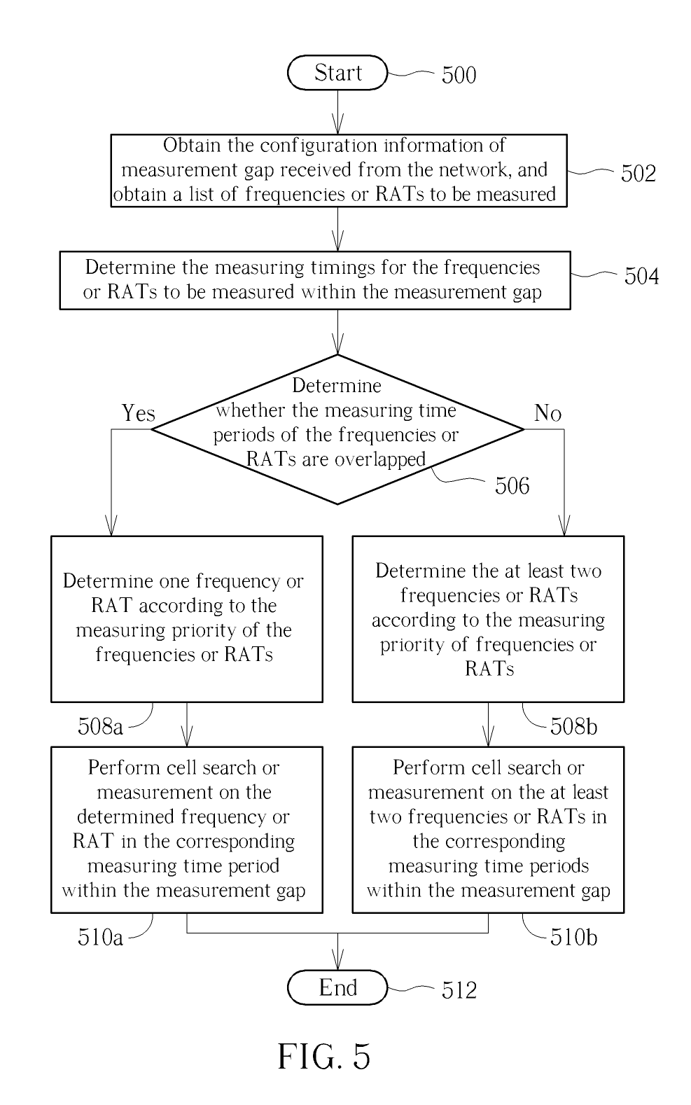

In an embodiment, the UE allocates frequencies or RATs in the measurement gap according to the measuring priority of frequencies or RATs. Please refer to FIG. 5, which is a flowchart of a measurement operation 50 according to an embodiment of the invention. The UE obtains the configuration information of measurement gap received from the network, and obtains a list of frequencies or RATs to be measured (step 502). The UE determines the measuring timings for the frequencies or RATs to be measured within the measurement gap based on the measurement gap configured by the network (step 504) and then determines whether the measuring time periods of the frequencies or RATs are overlapped (step 506). If the measuring time periods for the frequencies or RATs are overlapped, the UE determines one frequency or RAT according to the measuring priority of the frequencies or RATs (e.g., the frequency or RAT with the highest measuring priority) (step 508a), and performs cell search or measurement on the determined frequency or RAT in the corresponding measuring time period within the measurement gap (step 510a). On the other hand, if the measuring time periods of at least two of the frequencies or RATs are not overlapped, the UE determines the at least two frequencies or RATs according to the measuring priority of frequencies or RATs (step 508b), and performs cell search or measurement on the at least two frequencies or RATs in the corresponding measuring time periods within the measurement gap (step 510b). Note that, the measuring list may be configured by the network, stored in the UE or predefined message for the UE.

In addition, the concept of the present invention includes measurement on multiple frequencies or RATs within one measurement gap. Besides TDD transmission mode, the present invention can be applied to FDD transmission mode. Please refer to FIG. 2A, which is a schematic diagram of a UE 20a according to an embodiment. The UE 20a includes a processor 200a, a storage unit 210a including program code 214a, and communication interface units 220a-220b, which is similar to the UE 20 of FIG. 2. Compared to the FIG. 2, the UE 20a of FIG. 2A includes two or at least two communication interface units 220a-220b. For simplicity, FIG. 2A merely shows two communication interface units. However, a number of communication interface units are not limited herein.

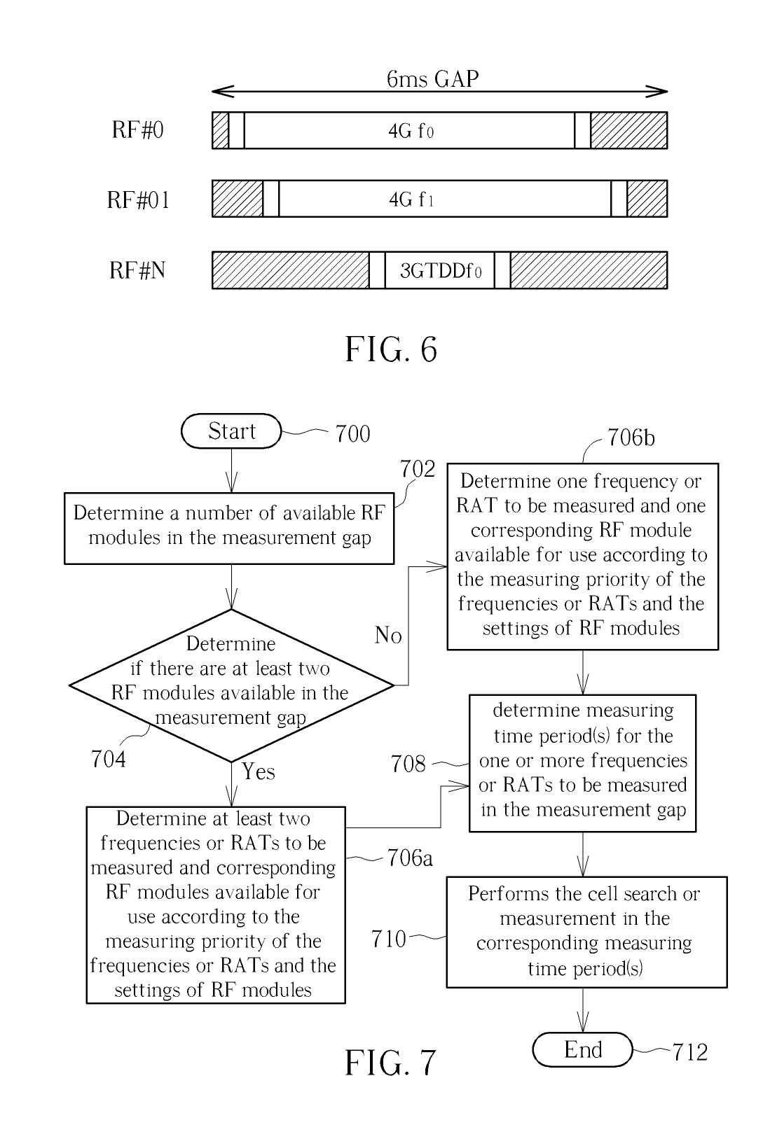

Please refer to FIG. 6, which is a schematic diagram of a measurement gap configuration according to an embodiment of the invention. In FIG. 6, the UE uses multiple RF modules RF#0, RF#1, . . . , RF#N (N≧1) for measuring different frequencies or RATs within a 6 ms measurement gap GAP. For example, the RF module RF#0 is used for measuring 4G frequency 4G f₀ within the measurement gap GAP, the RF module RF#1 is used for measuring 4G frequency 4G f₁ within the measurement gap GAP, and the RF module RF#N is used for measuring 3G frequency 3G TDD f₀ within the measurement gap GAP. It is noted that the allocation of RF modules for frequencies or RATs measurement may be performed in accordance with any one or any combination of the following rules:

(1) The RF modules are allocated according to the measuring priority of the frequencies or RATs (e.g., 4G>3G>2G);

(2) There is a dedicated mapping between radio frequency modules and the RATs. For example, each RF module is always assigned to a given RAT;

(3) The frequencies or RATs to be measured are allocated equally to the RF modules; and

(4) The frequencies or RATs to be measured are allocated to the RF modules according to frequency bands supported by the RF modules.

However, the allocation rules of RF modules for frequencies or RATs measurement are not limited herein.

For example, as shown in FIG. 6, if there are three available RF modules RF#0, RF#1 and RF#N for measurement in a measurement gap, the UE first allocates the 4G frequencies which have the highest priority (i.e. 4G f0 and 4G f1 of FIG. 6) to the available RF modules (i.e. RF#0 and RF#1 of FIG. 6) supporting the 4G frequency band, with a proper measuring time, and then allocates 3G frequencies (i.e. 3G TDD f0 of FIG. 6) with lower priority to the available RF module (i.e. RF#N of FIG. 6) with a proper measuring time.

In another embodiment, the UE allocates the frequencies or RATs measurement within the measurement gap according to the measuring priority of the frequencies or RATs. Please refer to FIG. 7, which is a flowchart of a measurement operation 70 incorporating with measurement gap configuration of FIG. 6. After the UE receives the measurement gap from the network, the UE determines a number of available RF modules in the measurement gap (step 702), wherein the number of the available RF modules are determined based on the current operation status of the UE, and therefore it may be smaller or equal to the maximum number of RF modules supported by the UE. Next, the UE determines if there are at least two RF modules available in the measurement gap (step 704). If there are at least two RF modules available for measurement, the UE determines at least two frequencies or RATs to be measured and corresponding RF modules available for use according to the measuring priority of the frequencies or RATs and the settings of RF modules (step 706a). On the other hand, if the number of the RF modules available for measurement is less than two (i.e., only one available RF module), the UE determines one frequency or RAT to be measured and one corresponding RF module available for use according to the measuring priority of the frequencies or RATs and the settings of RF modules (step 706b). Finally, the UE determines measuring time period(s) for the one or more frequencies or RATs to be measured in the measurement gap according to the measurement gap configuration (step 708) and performs the cell search or measurement in the corresponding measuring time period(s) (step 710).

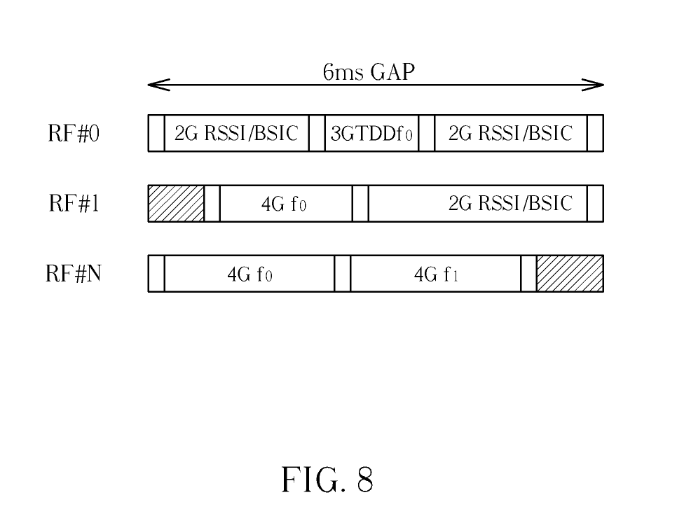

Please refer to FIG. 8, which is a schematic diagram of a measurement gap configuration according to an embodiment of the invention. In this embodiment, as shown in FIG. 8, the UE can perform measurement on different frequencies or RATs within three measurement gaps GAP with available RF modules RF#0, RF#1 and RF#N, respectively. For each RF module (e.g., RF#0, RF#1 and RF#N of FIG. 8), the UE divides the measurement gap GAP into a plurality of measuring time periods, so as to allocates different frequencies or RATs to be measured in one measurement gap GAP, which increases the utilization of the measurement gap GAP. Thus, the embodiments provided by the present disclosure may reduce the time of measuring all of frequencies or RATs and decrease the chance of data transmission interruption, which brings an improvement on the service quality.

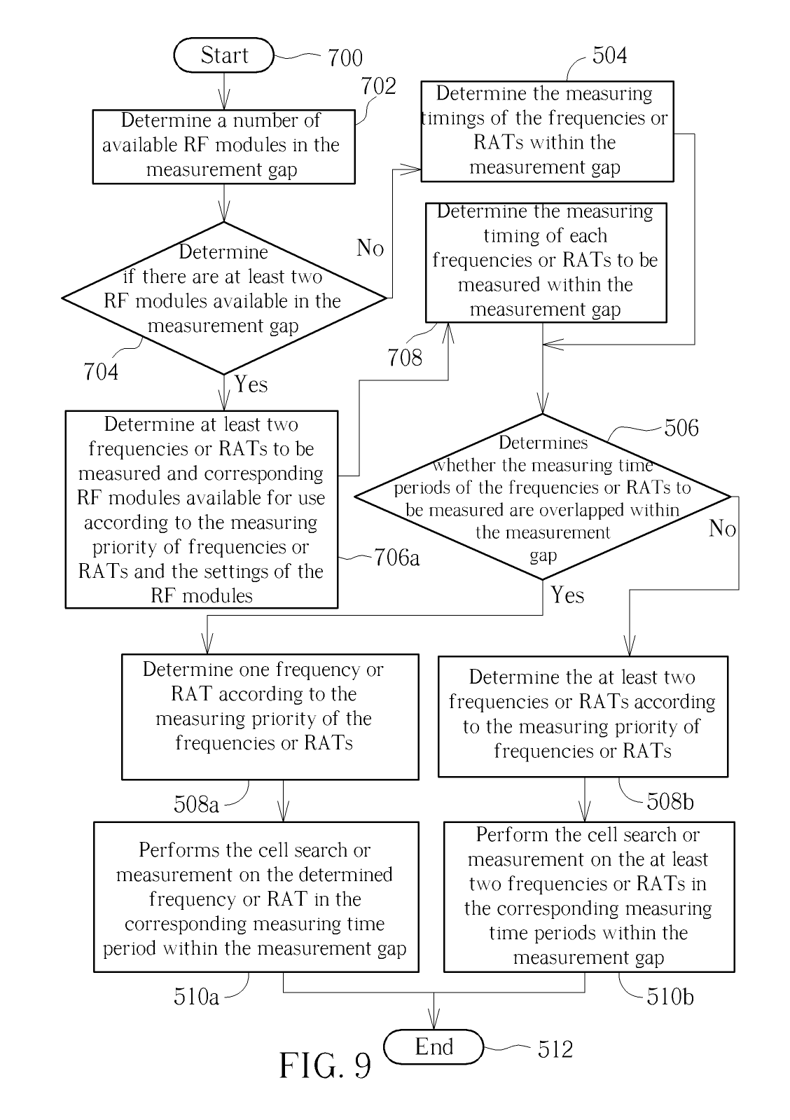

Please refer to FIG. 9, which is a flowchart of a measurement operation 90 incorporating with measurement gap configuration of FIG. 8. Measurement operation 90 may be incorporated with the measurement operations 50 and/or 70. Briefly, the UE first determines a number of RF modules available for measurement within the measurement gap (step 702), divides the measurement gap into a plurality of measuring time periods, and allocates the frequencies or RATs to be measured within the measurement gap according to the measuring priority of the frequencies or RATs. Further, the UE determines if there are at least two RF modules available in the measurement gap (step 704). If there are at least two RF modules available within the measurement gap, the UE determines at least two frequencies or RATs to be measured and corresponding RF modules available for use according to the measuring priority of frequencies or RATs and the settings of the RF modules (step 706a). In step 708, for each available RF module, the UE determines the measuring timing of each frequency or RAT to be measured within the measurement gap, and further determines whether the measuring time periods of the frequencies or RATs to be measured are overlapped within the measurement gap (step 506). If the measuring time periods of the frequencies or RATs to be measured are overlapped within the measurement gap, the UE determines one frequency or RAT according to the measuring priority of the frequencies or RATs (e.g., the frequency or RAT with the highest measuring priority) (step 508a), and then performs the cell search or measurement on the determined frequency or RAT in the corresponding measuring time period within the measurement gap (step 510a). On the other hand, if the measuring time periods of at least two frequencies or RATs to be measured are not overlapped within the measurement gap, the UE determines the at least two frequencies or RATs to be measured within the measurement gap according to the measuring priority of the frequencies or RATs (step 508b), and then performs the cell search or measurement on the at least two frequencies or RATs in the corresponding measuring time periods within the measurement gap (step 510b).

For example, as shown in FIG. 8, the UE determines three available RF modules RF#0, RF#1 and RF#N, wherein the RF module RF#0 supports 2G and 3G measurements, while RF#1 and RF#N supports 2G, 3G and 4G measurements. Since the measuring priority of RATs are 4G>_{3G}>2G, and for the 4G frequencies, the measuring priority are 4G f₀>4G f₁. Thus, for 4G f₀, 4G f₁, 3G TDD f₀ and 2G RSSI/BSIC measurements, the UE first allocates 4G f₀ to the RF#1 and RF#N which supports 4G frequencies in the corresponding measuring time periods of the measurement gaps since 4G f₀ has the highest measuring priority, and then allocates 4G f₁ to the RF modules RF#1 and RF#N respectively in the rest of measuring time periods of the measurement gaps. As shown in FIG. 8, the measuring time period of 4G f₁ is overlapped with that of 4G f₁ for RF#1, thus the UE allocates 4G f₁ to the RF modules RF#N only. Meanwhile, the UE allocates 3G TDD f₀ to the RF module RF#0 which supports 2G and 3G measurements in the corresponding measuring time period of the measurement gap. After allocating the measuring time periods of the measurement gap for the 4G f₀, 4G f₁ and 3G TDD f₀, the UE allocates 2G RSSI/BSIC measurement which has the lowest measuring priority to the RF modules supporting 2G measurement (i.e., RF#0, RF#1 and RF#N) in the rest of measuring time of the measurement gaps.

It is noted that, in step 704, if there is only one available RF module for measurement within the measurement gap, the UE determines the measuring timings of the frequencies or RATs within the measurement gap in the step 504. In addition, the UE determines whether the measuring time periods of the at least two frequencies or RATs to be measured are overlapped within the measurement gap (step 506). If the measuring time periods of the at least two frequencies or RATs are overlapped within the measurement gap, the UE determines one frequency or RAT to be measured first within the measurement gap according to the measuring priority of the frequencies or RATs (step 508a), and then performs the cell search or measurement on the frequency or RAT in the corresponding measuring time period within the measurement gap (step 510a). On the other hand, if the measuring time periods of the at least two frequencies or RATs to be measured are not overlapped within the measurement gap, the UE determines to measure the at least two frequencies or RATs within the measurement gap according to the measuring priority of the frequencies or RATs (step 508b), and then performs the cell search or measurement on the at least two frequencies or RATs in the corresponding measuring time periods within the measurement gap (step 510b). Detailed description can be referred to the abovementioned processes 50 and 70, and therefore is omitted herein.

In conclusion, the present invention provides a method for inter-frequency or inter-RAT measurement. The present invention aims at utilizing one measurement gap to perform measurement on multiple frequencies and RATs, to reduce the time for measuring all of the frequencies and RATs, reduce transmission interruption time, and thus increasing the transmission efficiency of the UE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of inter-frequency or inter-RAT (Radio Access Technology) measurement for a user equipment in a wireless communication system, the method comprising:
receiving configuration information of measurement gap from a network of the wireless communication system;
obtaining a list of frequencies or RATs to be measured; and
allocating at least two of the frequencies or RATs in the measurement gap, to perform cell search or measurement on the at least two frequencies or RATs within the measurement gap.

2. The method of claim 1, wherein the step of allocating the at least two of the frequencies or RAT to be measured in the measurement gap comprises:
dividing the measurement gap into a plurality of time periods; and
allocating the at least two of the frequencies or RATs in the plurality of time periods of the measurement gap according to a measuring priority of the frequencies or RATs to be measured in the list.

3. The method of claim 2, wherein the step of allocating the at least two of the frequencies or RATs to be measured in the plurality of time periods of the measurement gap according to the measuring priority of the frequencies or RATs to be measured in the list comprises:
allocating a first time period of the measurement gap for a frequency or RAT with the highest priority according to the measuring priority; and
allocating the rest of time periods of the measurement gap for another one of the frequencies or RATs according to the measuring priority.

4. The method of claim 2, wherein the step of dividing the measurement gap into the plurality of time periods comprises:
dividing the measurement gap into the plurality of time periods according to timing information associated with measurement of the frequencies or RATs.

5. The method of claim 1, wherein the step of allocating the at least two of the frequencies or RATs in the measurement gap comprises:
determining a number of radio frequency modules available for performing measurement on the at least two frequencies or RATs in the measurement gap;
dividing one or more of the measurement gaps each corresponding to an radio frequency module determined to be available for performing measurement into a plurality of time periods according to timing information associated with measurement of the at least two of the frequencies or RATs; and
allocating the at least two frequencies or RATs to one or more radio frequency modules determined to be available for performing measurement according to the measuring priority of the frequencies or RATs in the list.

6. The method of claim 5, wherein when the number of the radio frequency modules available for performing measurement is larger than or equal to two, for at least one of the radio frequency modules available for performing measurement, allocating the at least two of the frequencies or RATs in the plurality of time periods of the measurement gap according to the measuring priority.

7. The method of claim 6, wherein the step of for at least one of the radio frequency module available for performing measurement, allocating the at least two of the frequencies or RATs in the plurality of time periods of the measurement gap according to the measuring priority comprises:
allocating a first time period of the measurement gap corresponding to one of the available radio frequency modules for a frequency or RAT with the highest priority according to the measuring priority; and
allocating the rest of time periods of the measurement gap for another one of the frequencies or RATs to be measured according to the measuring priority.

8. The method of claim 2, wherein the measuring priority indicates at least one of a priority order of the RATs, a mapping between the radio frequency modules and the RATs, and a mapping between the radio frequency modules and the frequencies.

9. The method of claim 2, wherein the timing information includes at least two of a start time, duration time, and end time of the measurement.

10. A user equipment for inter-frequency or inter-RAT (Radio Access Technology) measurement in a wireless communication system, the user equipment comprising:
at least one radio frequency module; and
a processor, coupled to the at least one radio frequency module, for receiving configuration information of measurement gap from a network of the wireless communication system via the at least one radio frequency module, obtaining a list of frequencies or RATs to be measured, and allocating at least two of the frequencies or RATs in the measurement gap, to perform measurement or cell search on the at least two frequencies or RATs within the measurement gap.

11. The user equipment of claim 10, wherein the step of allocating at least two of the frequencies or RATs in the measurement gap comprising:
dividing the measurement gap into a plurality of time periods by the processor; and
allocating the at least two of the frequencies or RATs in the plurality of time periods of the measurement gap by the processor according to a measuring priority of the frequencies or RATs in the list.

12. The user equipment of claim 11, wherein the step of allocating the at least two of the frequencies or RATs in the plurality of time periods of the measurement gap by the processor according to a measuring priority of the frequencies or RATs in the list comprising:
allocating a first time period of the measurement gap by the processor for a frequency or RAT with the highest priority according to the measuring priority; and
allocating the rest of time periods of the measurement gap by the processor for another one of the frequencies or RATs in the list according to the measuring priority.

13. The user equipment of claim 11, wherein the processor is further used for dividing the measurement gap into the plurality of time periods according to timing information associated with measurement of the at least two of the frequencies or RATs.

14. The user equipment of claim 10, wherein the step of allocating at least two of the frequencies or RATs in the measurement gap comprising:
determining by the processor a number of radio frequency modules available for performing measurement on the at least two frequencies or RATs in the measurement gap;
dividing one or more of the measurement gaps each corresponding to an radio frequency module determined to be available for performing measurement into a plurality of time periods by the processor according to timing information associated with measurement of the at least two of frequencies or RATs; and
allocating the at least two frequencies or RATs to one or more radio frequency modules determined to be available for performing measurement by the processor according to the measuring priority of the frequencies or RATs in the list.

15. The user equipment of claim 14, wherein when the number of the radio frequency modules available for performing measurement is larger than or equal to two, for at least one of the radio frequency modules available for performing measurement, the processor allocates the at least two of the frequencies or RATs in the plurality of time periods of the measurement gap according to the measuring priority.

16. The user equipment of claim 15, wherein for the at least one of the radio frequency modules available for performing measurement, when the processor allocates the at least two of the frequencies or RATs in the plurality of time periods of the measurement gap according to the measuring priority, the processor allocates a first time period of the measurement gap corresponding to one of the available radio frequency modules for a frequency or RAT with the highest priority according to the measuring priority, and allocates the rest of time periods of the measurement gap for another one of the frequencies or RATs to be measured according to the measuring priority.

17. The user equipment of claim 14, wherein the timing information includes at least two of a start time, duration time, and end time of the measurement.
